(19) United States
(12) Patent Application Publication
(10) Pub. No.: US 2024/0248665 A1
(43) Pub. Date: Jul. 25, 2024

(54) RESOURCE RENDERING METHOD AND APPARATUS, DEVICE, COMPUTER READABLE STORAGE MEDIUM, AND COMPUTER PROGRAM PRODUCT

(71) Applicant: Tencent Technology (Shenzhen) Company Limited, Shenzhen (CN)

(72) Inventor: Shuai Lou, Shenzhen (CN)

(73) Assignee: Tencent Technology (Shenzhen) Company Limited, Shenzhen (CN)

(21) Appl. No.: 18/626,853

(22) Filed: Apr. 4, 2024

Related U.S. Application Data
(63) Continuation of application No. PCT/CN2023/095742, filed on May 23, 2023.

(30) Foreign Application Priority Data
Aug. 3, 2022 (CN) 202210925137.2

(51) Int. Cl. G06F 3/14

(52) U.S. Cl. CPC G06F 3/14

(57) ABSTRACT

A resource rendering method/apparatus including obtaining, based on a resource rendering request for a target object in a geographical area, a node relationship graph corresponding to the geographical area, the node relationship graph comprising at least one node in a connection relationship, the at least one node corresponding to a terminal in the geographical area, and the at least one node comprising a rendering execution node shared by nodes in the geographical area, identifying, in the node relationship graph, a node path from the at least one node to the rendering execution node, transferring the resource rendering request to the rendering execution node according to the node path, the resource rendering request instructing the rendering execution node to render the target object by using a cloud to obtain a rendering resource, and receiving the rendering resource returned by the rendering execution node, and displaying the rendering resource.

### CROSS-REFERENCE TO RELATED APPLICATIONS

This application is a continuation application of International Application No. PCT/CN2023/095742 filed on May 23, 2023, which claims priority to Chinese Patent Application No. 202210925137.2 filed with the China National Intellectual Property Administration on Aug. 3, 2022, the disclosures of each being incorporated by reference herein in their entireties.

### FIELD

The disclosure relates to the field of Internet technologies, and in particular, to a resource rendering method and apparatus, a computer device, a computer readable storage medium, and a computer program product.

### BACKGROUND

With rapid development of Internet technologies, cloud rendering products are widely used, for example, applied to scenarios such as map navigation, smart travel, smart transport, and games. In a related technology, a cloud allocates a corresponding cloud rendering instance to each resource rendering request for resource rendering, and transmits a rendering resource to a corresponding terminal, so as to display corresponding content in the terminal.

However, costs of a cloud rendering instance running in the cloud are relatively high. When multiple users in the same rendering node trigger resource rendering requests for the same content, the cloud separately allocates different cloud rendering instances to the multiple resource rendering requests for resource rendering. Consequently, repeated resource rendering causes relatively low resource rendering efficiency, and resource utilization is relatively low.

### SUMMARY

Some embodiments provide a resource rendering method and apparatus, a computer device, a computer readable storage medium, and a computer program product, which can improve resource rendering efficiency and improve resource utilization.

Some embodiments provide a resource rendering method, including: obtaining, based on a resource rendering request for a target object in a geographical area, a node relationship graph corresponding to the geographical area, the node relationship graph comprising at least one node in a connection relationship, the at least one node corresponding to a terminal in the geographical area, and the at least one node comprising a rendering execution node shared by nodes in the geographical area; identifying, in the node relationship graph, a node path from the at least one node to the rendering execution node; transferring the resource rendering request to the rendering execution node according to the node path, the resource rendering request instructing the rendering execution node to render the target object by using a cloud to obtain a rendering resource; and receiving the rendering resource returned by the rendering execution node, and displaying the rendering resource.

Some embodiments provide a resource rendering apparatus, including: at least one memory configured to store program code; and at least one processor configured to read the program code and operate as instructed by the program code, the program code comprising: node relationship graph obtaining code configured to cause at least one of the at least one processor to obtain, based on a resource rendering request for a target object in a geographical area, a node relationship graph corresponding to the geographical area, the node relationship graph comprising at least one node in a connection relationship, the at least one node corresponding to a terminal in the geographical area, and the at least one node comprising a rendering execution node shared by nodes in the geographical area; path identification code configured to cause at least one of the at least one processor to identify, in the node relationship graph, a node path from the at least one node to the rendering execution node; request transfer code configured to cause at least one of the at least one processor to transfer the resource rendering request to the rendering execution node according to the node path, the resource rendering request instructing the rendering execution node to render the target object by using a cloud to obtain a rendering resource; and resource display code configured to cause at least one of the at least one processor to receive the rendering resource returned by the rendering execution node, and display the rendering resource.

Some embodiments provide a non-transitory computer-readable storage medium storing computer code which, when executed by at least one processor, causes the at least one processor to at least: obtain, based on a resource rendering request for a target object in a geographical area, a node relationship graph corresponding to the geographical area, the node relationship graph comprising at least one node in a connection relationship, the at least one node corresponding to a terminal in the geographical area, and the at least one node comprising a rendering execution node shared by nodes in the geographical area; identify, in the node relationship graph, a node path from the at least one node to the rendering execution node; transfer the resource rendering request to the rendering execution node according to the node path, the resource rendering request instructing the rendering execution node to render the target object by using a cloud to obtain a rendering resource; and receive the rendering resource returned by the rendering execution node, and display the rendering resource.

According to some embodiments, based on a resource rendering request for a target object in a geographical area, a node relationship graph corresponding to the geographical area is obtained, the node relationship graph including at least one node in a connection relationship, the node corresponding to a terminal in the geographical area, and the node including a common rendering execution node shared by nodes in the geographical area; in the node relationship graph, a node path from the node to the rendering execution node is identified; the resource rendering request is transferred to the rendering execution node according to the node path, the resource rendering request being used for instructing the rendering execution node to render the target object by using a cloud to obtain a rendering resource; and the rendering resource corresponding to the target object and returned by the rendering execution node is received, and the rendering resource is displayed. Because the node relationship graph is corresponding to the geographical area, each node transfers the resource rendering request based on the node relationship graph, and the rendering execution node is jointly owned by each node in the node relationship graph. In this way, the rendering execution node can process the resource rendering request sent by the terminal corresponding to each node. When there are resource rendering requests for the same target object in resource rendering requests sent by different nodes, the rendering execution node does not need to request the cloud to repeatedly render the target object, thereby implementing reuse of the same rendering resource in the geographical area, reducing repeated processing of a resource rendering request generated in the geographical area, reducing repeated rendering of the same object by the cloud, and improving resource rendering efficiency, thereby improving resource utilization.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an implementation scenario of a resource rendering method according to some embodiments.

FIG. 2 is a schematic flowchart of a resource rendering method according to some embodiments.

FIG. 3A is a schematic diagram of a node relationship graph of a resource rendering method according to some embodiments.

FIG. 3B is a schematic flowchart of a resource rendering method according to some embodiments.

FIG. 3C is another schematic flowchart of a resource rendering method according to some embodiments.

FIG. 4 is another schematic flowchart of a resource rendering method according to some embodiments.

FIG. 5 is a schematic structural diagram of a resource rendering apparatus according to some embodiments.

FIG. 6 is a schematic structural diagram of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure and the appended claims.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Some embodiments provide a resource rendering method and apparatus, a computer device, a computer readable storage medium, and a computer program product. The resource rendering apparatus may be integrated into the computer device, and the computer device may be a device such as a server or a terminal.

The server may be an independent physical server, or may be a server cluster or a distributed system formed by multiple physical servers, or may be a cloud server that provides basic cloud computing service such as a cloud service, a cloud database, cloud computing, a cloud function, cloud storage, a network service, cloud communication, a middleware service, a domain name service, a security service, a network acceleration service (Content Delivery Network, CDN), big data, and an artificial intelligence platform. The terminal may include but is not limited to a mobile phone, a computer, an intelligent voice interaction device, a smart home appliance, an in-vehicle terminal, an augmented reality (AR) device, an aircraft, and the like. The terminal and the server may be directly or indirectly connected in a wired or wireless communication manner, which is not limited herein.

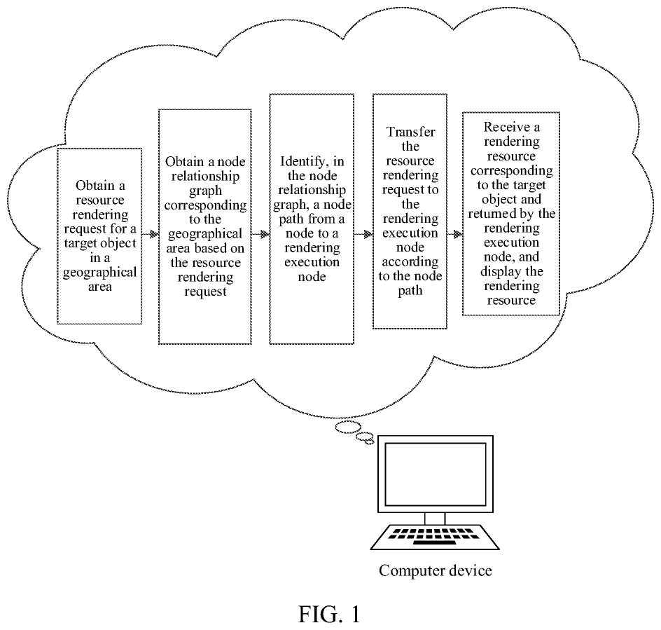

FIG. 1 is a schematic diagram of an implementation scenario of a resource rendering method according to some embodiments. The computer device may be a terminal, and the terminal corresponds to a node in a node relationship graph. The node relationship graph is corresponding to a geographical area in which the terminal is located, and the terminal may obtain a resource rendering request for a target object in the geographical area; obtain, based on the resource rendering request, the node relationship graph corresponding to the geographical area, the node relationship graph including at least one node in a connection relationship (for example, the node relationship graph includes at least two nodes in a connection relationship), each node corresponding to at least one terminal in the geographical area, and the node including a common rendering execution node of nodes in the geographical area; identify, in the node relationship graph, a node path from the node to the rendering execution node; transfer the resource rendering request to the rendering execution node according to the node path, the resource rendering request being used for instructing the rendering execution node to render the target object by using a cloud; and receive the rendering resource corresponding to the target object and returned by the rendering execution node, and display the rendering resource.

Some embodiments may be applied to various scenarios, including but not limited to a cloud technology, artificial intelligence, smart transport, and aided driving. The schematic diagram of the implementation environment scenario of the resource rendering method shown in FIG. 1 is merely an example. The implementation environment scenario of the resource rendering method described in some embodiments is used for describing technical solutions more clearly, and does not constitute a limitation on the technical solution provided herein. A person of ordinary skill in the art may learn that, with evolution of resource rendering and emergence of a new service scenario, the technical solutions provided in some embodiments are also applicable to a similar technical problem.

The solutions provided in some embodiments are described by using the following embodiments. A description sequence of the following embodiments is not intended to limit the sequence of the embodiments.

Some embodiments are described from a perspective of a resource rendering apparatus. The resource rendering apparatus may be integrated into a computer device. The computer device may be a terminal or a server. This is not limited herein.

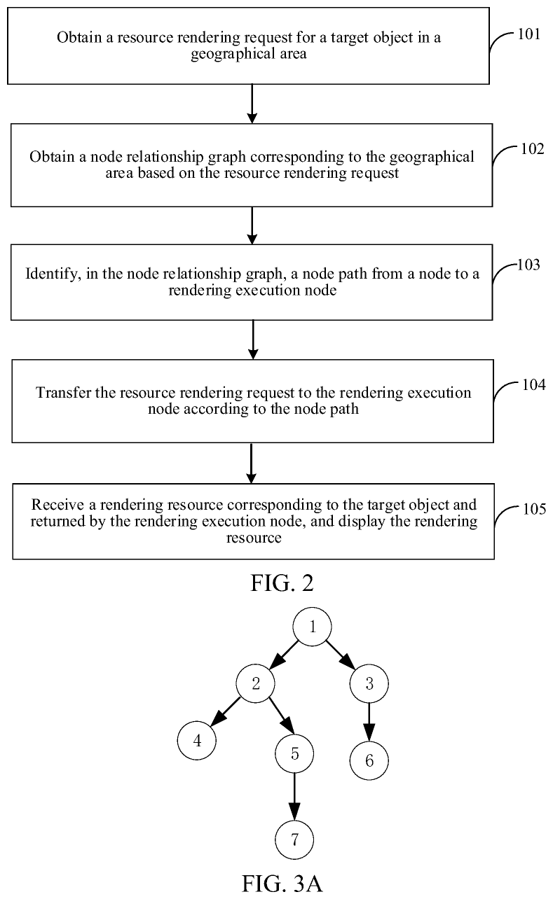

FIG. 2 is a schematic flowchart of a resource rendering method according to some embodiments. The resource rendering method may be separately performed by a terminal or a server, or may be jointly performed by a terminal and a server. For example, the resource rendering method is performed by a terminal, and the terminal may be corresponding to a node in a node relationship graph. The resource rendering method includes the following operations:

Operation 101: Obtain a resource rendering request for a target object in a geographical area.

The geographical area may be a pre-partitioned area with a boundary. For example, the geographical area may be a virtual geographical area surrounded by a virtual fence. For example, a geo-fencing technology may be used. Multiple virtual geographical boundaries are enclosed in an area by using virtual fences, so that multiple geographical areas in the area can be obtained. The target object may be multiple types of objects that can be rendered, such as a map view, a video, and a picture, and the map view may be a map picture displayed in a virtual scenario. The resource rendering request may be used for requesting to perform cloud rendering on the target object. For example, the terminal currently runs a map application and displays a map view. When a user triggers a click/tap operation, a move forward operation, or a rotate operation on the current map view, the terminal needs to update the displayed map view, and correspondingly triggers generation of a resource rendering request.

In some embodiments, when there are too many resource rendering requests generated in the geographical area, to avoid multiplied occupation and consumption of cloud resources due to repeated requests and repeated resource rendering caused by the same resource rendering request, obtained resource rendering requests may be combined before the resource rendering requests are uploaded to the cloud. In some embodiments, the resource rendering requests generated in the geographical area may be combined according to a rendering object corresponding to each resource rendering request in the geographical area. For example, it is assumed that three resource rendering requests for a target object A (for example, three same map views) are obtained in the same geographical area. In this case, the three resource rendering requests for the target object A may be combined into one request, so as to request, based on the request, a rendering resource corresponding to the target object A from the cloud, and then perform distribution on and display the rendering resource according to the three resource rendering requests. For another example, it is assumed that two move forward operations triggered for the same map view are generated in the geographical area at the same time, and generation of two resource rendering requests in response to the move forward operation on the map view is triggered accordingly. In this case, because rendering objects corresponding to the two resource rendering requests are the same, the two resource rendering requests may be combined into one resource rendering request, and a rendering resource in response to the move forward operation on the map view may be requested from the cloud based on the resource rendering request.

In some embodiments, a rendering execution node may receive a geographical fence parameter corresponding to the current geographical area delivered by the cloud, and may determine a geographical fence range of the current geographical area according to the geographical fence parameter, so that the rendering execution node can send heartbeat information to a node (that is, the terminal) in the geographical area, so as to establish a communication connection between nodes in the geographical area. The geographical fence parameter may be a parameter used for determining a range of the geographical area, and the rendering execution node may be a randomly selected node in the geographical area.

Operation 102: Obtain a node relationship graph corresponding to the geographical area based on the resource rendering request.

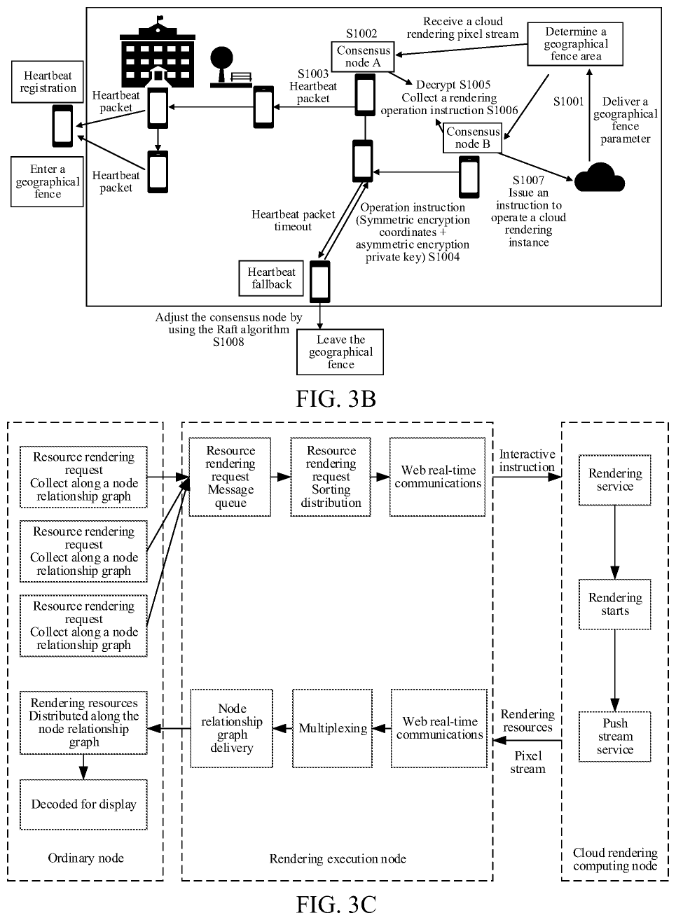

The node relationship graph may include at least one node in a connection relationship, where the node is corresponding to a terminal in the geographical area, that is, each node may be corresponding to a terminal in the geographical area. In this case, when there are multiple (at least two) terminals in the geographical area, the corresponding node relationship graph includes nodes respectively corresponding to the multiple terminals. The nodes in the node relationship graph may include a common rendering execution node of all nodes. The rendering execution node may be a node that executes resource rendering requests in the geographical area, that is, the rendering execution node can be used for processing resource rendering requests sent by all terminals in the geographical area, that is, managing all the resource rendering requests generated in the geographical area, and exchanging information with the cloud and the nodes based on the resource rendering requests. For example, the rendering execution node may receive the resource rendering requests generated in the geographical area, upload the received resource rendering requests to the cloud, receive rendering resources returned by the cloud, and distribute the rendering resources to corresponding nodes. The rendering resource may be a resource that is used for rendering by the cloud based on the resource rendering request and that is delivered to the geographical area. For example, when the target object is a map view in a map application, the rendering resource is a rendering result (for example, a video stream or a pixel stream) obtained by the cloud by rendering the map view. The node relationship graph may be a data structure that represents a connection relationship between nodes in the geographical area, and nodes in the node relationship graph are connected by using edges. For example, the node relationship graph may be a directed acyclic graph (DAG). A direction of an edge in the node relationship graph may be that a parent node points to a child node thereof, and two nodes in the node relationship graph are connected by using one edge, which may indicate that a communication connection may be established between the two nodes. For example, referring to FIG. 3A, FIG. 3A is a schematic diagram of a node relationship graph of a resource rendering method according to some embodiments. The node relationship graph includes a node 1, a node 2, a node 3, a node 4, a node 5, a node 6, and a node 7 in a geographical area. It is assumed that the node 1 is a rendering execution node, the node 2 and the node 3 are child nodes of the node 1, the node 4 and the node 5 are child nodes of the node 2, the node 6 is a child node of the node 3, the node 5 is a parent node of the node 7, and the node 7 is a child node of the node 5. In addition, the node relationship graph may be a data structure of a blockchain type, or the like.

There may be multiple manners of obtaining the node relationship graph corresponding to the geographical area based on the resource rendering request. There is a corresponding resource cache pool in the geographical area. The resource cache pool stores rendering resources corresponding to different objects (such as a map view). In actual application, the geographical area and the resource cache pool may be in a one-to-one correspondence. For the correspondence, the resource cache pool may store rendering resources of different objects corresponding to historical resource rendering requests in the geographical area. For example, based on the target object, a target rendering resource that matches the resource rendering request may be searched in a resource cache pool corresponding to the geographical area (that is, the target rendering resource corresponding to the target object is searched). When the target rendering resource is not found, the node relationship graph corresponding to the geographical area is obtained.

The resource cache pool may be a cache pool used for storing a rendering resource corresponding to the geographical area, and the target rendering resource may be a rendering resource corresponding to the target object, that is, may be a rendering resource in the resource cache pool and corresponding to the target object.

In some embodiments, when the target rendering resource is found, the target rendering resource may be used as a rendering resource corresponding to the resource rendering request, and distributed to a node that needs to display the target rendering resource for display.

In some embodiments, after the rendering resource is obtained from the cloud based on the resource rendering request, the rendering resource may be stored in the resource cache pool corresponding to the geographical area. When a resource rendering request for the same object is generated again in the geographical area, a rendering resource corresponding to the object may be extracted from the resource cache pool, so that reuse of the same rendering resource in the geographical area can be implemented, resource rendering efficiency is improved, resource consumption and occupation of the cloud are reduced, and resource utilization is further improved.

In some embodiments, before the node relationship graph corresponding to the geographical area is obtained based on the resource rendering request, the node relationship graph corresponding to the geographical area may be further constructed. There may be multiple manners of constructing the node relationship graph corresponding to the geographical area. For example, a node connection relationship between any two nodes in the geographical area may be obtained, and the node relationship graph corresponding to the geographical area is constructed based on the node connection relationship. For example, a communication connection relationship between any two terminals in a geographical area is obtained, and a node relationship graph corresponding to the geographical area is constructed based on the communication connection relationship.

The node connection relationship may be a connection relationship between any two nodes in the geographical area. For example, the node connection relationship may include a relationship of establishing a connection and a relationship of not establishing a connection.

There may be multiple manners of obtaining a node connection relationship between any two nodes in a geographical area. For example, the resource rendering method provided in some embodiments may be implemented by a resource rendering system or a resource rendering apparatus. The resource rendering system may include a rendering execution node and another node, and the resource rendering apparatus may integrate the rendering execution node and another node. Therefore, based on the resource rendering system or the resource rendering apparatus, the rendering execution node may send heartbeat information to the another node in the geographical area, receive response information returned by the another node for the heartbeat information, and determine, from the another node according to the response information, at least one child node corresponding to the rendering execution node. Each child node may send heartbeat information to another node in the geographical area, and then determine, according to response information returned by the another node for the heartbeat information sent by the child node, a next-level child node corresponding to each child node. By analogy, after connection and transmission of nodes in the current geographical area is stable, a connection relationship between each node in the geographical area and another node may be obtained, and a node relationship graph corresponding to the geographical area may be constructed based on a connection relationship between nodes. The heartbeat information may be a heartbeat packet sent by the node.

When a mobile terminal device corresponding to the node is about to enter the geographical area, a heartbeat packet sent by another node near an edge of the geographical area is received. Because heartbeat packets sent by multiple nodes may be received, to avoid excessive resource occupation, heartbeat registration may be performed on only some nodes. In some embodiments, a list may be maintained in each to-be-registered node, to store a sequence of receiving heartbeat packets, and perform bidirectional registration from the list header. If the heartbeat times out, subsequent heartbeat packets are successively obtained from the list to attempt to establish a heartbeat connection to a next node. If all heartbeat packets in the list cannot establish a connection, it may be determined whether a mobile terminal device corresponding to a current node is located in the geographical area. If the node is located in the geographical area, the node may be separately changed into an isolated node, and the isolated node is directly sent to the cloud. The cloud uniformly allocates an instance resource, and is responsible for deploying resource rendering requests of these isolated nodes. If the node is not in the geographical area, and a heartbeat packet of the node times out for a parent node corresponding to the node, it may be considered that heartbeat fallback occurs on the node, that is, an abandoned node.

FIG. 3A is a schematic diagram of a node relationship of a resource rendering method according to some embodiments. FIG. 3B is a schematic flowchart of a resource rendering method according to some embodiments. With reference to FIG. 3A and FIG. 3B, the resource rendering method provided in some embodiments is described.

Operation S1001: A consensus node B in a geographical area receives a geographical fence parameter delivered by a cloud, and determines a range of the geographical area.

When a node enters a geographical fence corresponding to the geographical area, a heartbeat packet sent by another node may be received, so that heartbeat registration may be performed.

In some embodiments, the node relationship graph may be updated according to a change in a connection relationship of nodes in the geographical area. For example, the node relationship graph may include a parent node and a child node, and the parent node may be a previous-level node of the child node. If heartbeat fallback occurs on a middle parent node in the node relationship graph in a transmission process, all child nodes of the parent node need to adjust a structure of the node relationship graph again, and a new neighboring node is selected as a parent node based on an original structure of the node relationship graph, so as to complete a heartbeat connection. For example, a node status of a parent node corresponding to a current node may be detected. When the node status is a heartbeat fallback state, a neighboring node of the current node is searched in the geographical area based on the node relationship graph, the neighboring node is used as a new parent node of the current node, a connection is established with the new parent node, and the node relationship graph is updated based on a connection relationship between the current node and the new parent node.

The node status may be a state of a node in a running process, and may include a normal state, a heartbeat fallback state, and the like. The heartbeat fallback state may be a state corresponding to a heartbeat timeout of the node, and the neighboring node may be a node in the geographical area and close to the location of the current node. The new parent node may be an updated parent node of the current node.

There may be multiple manners of determining the rendering execution node in the geographical area. For example, a consensus algorithm may be used for determining, from nodes in the geographical area, a node that is used as a rendering execution node. In some embodiments, a consensus algorithm such as a distributed consistency algorithm (Raft) may be used. The rendering execution node may be a consensus node in the geographical area, that is, a leader. Another node in the geographical area may be used as an ordinary node, that is, a follower of the rendering execution node, or may be used as a candidate in some specific election cases (for example, a lack of a leader). If a node in the geographical area does not receive a heartbeat packet from the leader within a period of time, in this case, the leader may be faulty, the node may switch from a follower to a candidate, and initiate election of a consensus node. If a node in the geographical area receives approval of a majority, the state of the node may be switched to the leader state, and used as the rendering execution node. In some embodiments, when it is found that another node in the geographical area performs an update operation on the node itself, the current rendering execution node may actively switch to the follower state, so as to implement update of a to-be-updated node. In this way, by using the consensus algorithm, validity of the rendering execution node in the geographical area can be periodically ensured, so as to avoid a case in which another node in the geographical area has to initiate a cloud connection request on its own because of a failure of the rendering execution node, thereby causing a resource rendering delay and accumulation of instructions transmitted by multiple nodes, and improving resource rendering efficiency.

For example, still referring to FIG. 3B, the node connection relationship in the geographical area is determined between nodes in the geographical area by sending a heartbeat packet periodically, so that the node relationship graph corresponding to the geographical area can be updated. The geographical area includes a consensus node A and a consensus node B.

Operation S1002: The consensus node A receives a cloud rendered pixel stream delivered by the cloud.

Operation S1003: The consensus node A sends a heartbeat packet to a child node thereof.

Herein, the consensus node A can periodically indicate a node status thereof by sending a heartbeat packet.

Operation S1004: When generating a resource rendering request, the node encrypts the resource rendering request, and then transmits the resource rendering request to a parent node thereof.

For example, an operation instruction corresponding to the resource rendering request may be encrypted in symmetrically encrypted coordinate and asymmetrically encrypted private key manners.

Operation S1005: The consensus node A decrypts a collected resource rendering request to obtain a decrypted resource rendering request.

Operation S1006: The consensus node B collects a resource rendering request in the geographical area according to the node relationship graph.

Operation S1007: The consensus node B sends a corresponding resource rendering instruction to the cloud based on the collected resource rendering request.

Herein, the resource rendering instruction is sent to the cloud, so as to instruct a cloud rendering computing node in the cloud to operate a cloud rendering instance.

Operation 51008: Adjust the consensus node in the geographical area by using the Raft consensus algorithm according to a status of the parent node.

After a node leaves a geographical fence, because a heartbeat packet times out, a parent node of the node may determine that a heartbeat of the node falls back, and the node in the geographical area may adjust the consensus node in the geographical area by using the Raft consensus algorithm according to a status of the parent node.

Operation 103: Identify, in the node relationship graph, a node path from the node to the rendering execution node.

The node path may be a path of a node in the geographical area that is connected to the rendering execution node. For example, still referring to FIG. 3A, if the node 1 is a rendering execution node, a node path from the node 4 to the rendering execution node may be the node 4 to the node 2 to the node 1, and a node path from the node 7 to the rendering execution node may be the node 7 to the node 5 to the node 2 to the node 1.

In the node relationship graph, the node path from the node to the rendering execution node may be identified in multiple manners. For example, when multiple candidate rendering execution nodes existing in the geographical area is detected according to the node relationship graph, a resource occupation status of the candidate rendering execution node may be obtained. When the resource occupation status is a sufficient state, path distribution corresponding to the candidate rendering execution node is identified according to the node relationship graph. A rendering execution node is selected from the multiple candidate rendering execution nodes based on the path distribution. A rendering execution permission corresponding to the candidate rendering execution node is combined into the rendering execution node, that is, the rendering execution node has an execution permission of each candidate rendering execution node, and a node path from the node to the rendering execution node is identified based on the node relationship graph.

The candidate rendering execution nodes may be multiple rendering execution nodes that exist in the geographical area, and the resource occupation status may represent a resource occupation situation of a candidate rendering execution node, and may include resource states such as a sufficient state and a scarce state. In some embodiments, when the resource occupation status is the sufficient state, it indicates that resources occupied by the candidate rendering execution node are less; and when the resource occupation status is the scarce state, it indicates that resources occupied by the candidate rendering execution node are more. The path distribution may be information representing a connection relationship between the rendering execution node and another node in the geographical area. The rendering execution permission may be a permission of the candidate rendering execution node in executing the resource rendering request in the geographical area. After the rendering execution permission is transferred to the rendering execution node, the candidate rendering execution node becomes an ordinary node.

Based on the path distribution, there may be multiple manners of selecting the rendering execution node from the candidate rendering execution nodes. For example, path complexity of each candidate rendering execution node may be identified according to path distribution corresponding to the candidate rendering execution node, so that a candidate rendering execution node with highest path complexity can be used as a rendering execution node corresponding to the geographical area. The path complexity may represent complexity of a connection relationship between each candidate execution node and a node in a geographical area. For example, the path complexity may include a path length, a path node quantity, and the like. The path length may be a node quantity of a node connection path corresponding to the candidate rendering execution node. For example, still referring to FIG. 3A, a path length from the node 1 to the node 7 is four nodes, a path length from the node 1 to the node is three nodes, and the path node quantity may be a quantity of child nodes corresponding to the candidate execution node. For example, a path node quantity corresponding to the node 1 is 6, and a path node quantity corresponding to the node 2 is 3. In this way, a candidate rendering execution node with a longest path length may be determined as a rendering execution node, or a candidate rendering execution node with a largest path node quantity may be determined as a rendering execution node.

Based on the node relationship graph, there may be multiple manners of identifying the node path from the node to the rendering execution node. For example, the candidate rendering execution node may be used as a child node of the rendering execution node, and a connection relationship between the candidate rendering execution node and the child node is maintained, so that the node relationship graph can be updated, and the node path from the node to the rendering execution node can be identified in the updated node relationship graph.

In some embodiments, when the rendering execution node in the geographical area falls back, another node in the geographical area will select a new rendering execution node to be responsible for a resource rendering request in the geographical area and immediately establish a pixel streaming connection to the cloud. In this case, there are very likely multiple rendering execution nodes in the geographical area. Existence of the multiple rendering execution nodes starts multiple cloud rendering instances in the cloud, so as to improve resource occupation of the cloud. After connection and transmission of nodes in a current geographical area are stable, a combination operation is dynamically performed on rendering execution nodes based on distribution of the rendering execution nodes in the geographical area, and structures of the rendering execution nodes are combined, so that resource occupation of a cloud rendering instance can be reduced while the rendering execution nodes are reduced. For example, multiple rendering execution nodes may be combined according to a resource occupation status of each rendering execution node. For example, when a resource occupation rate of the rendering node is relatively low, it may indicate that a management resource that is provided by the rendering execution node in the geographical area and that is for a resource rendering request in the geographical area is excessive. In this case, the multiple rendering execution nodes may be combined according to a resource rendering requirement in the geographical area, to obtain a target rendering node corresponding to the geographical area, so as to reduce a quantity of rendering execution nodes, thereby reducing a start rate and an occupation rate of the cloud resource. The target rendering execution node may be a rendering execution node obtained after the rendering execution nodes are combined according to the resource rendering requirement of the geographical area.

The multiple rendering execution nodes may be combined according to the resource rendering requirement in the geographical area in multiple manners. For example, a quantity of rendering execution nodes required in the geographical area may be determined according to the resource rendering requirement in the geographical area and a resource occupation status of each rendering execution node, so that the multiple rendering execution nodes can be combined according to the quantity of rendering execution nodes.

Based on the quantity of rendering execution nodes, the multiple rendering execution nodes may be combined in multiple manners. For example, rendering nodes that occupy relatively low rendering execution resources may be combined. In some embodiments, the multiple rendering execution nodes may be sorted from the lowest to the highest according to resource usage of each rendering execution node, so that a rendering execution node, in the sorted rendering execution nodes, whose ranking is corresponding to the quantity of rendering execution nodes may be determined as a target rendering execution node, that is, selection is performed in sequence starting from the first rendering execution node in the sorted multiple rendering execution nodes until a required quantity of rendering execution nodes are selected, so that a rendering execution permission corresponding to another rendering execution node can be transferred to the target rendering execution node, so as to implement a combination operation on rendering execution nodes. For example, it is assumed that the quantity of rendering execution nodes is 3, after the rendering execution nodes are sorted from the lowest to the highest according to resource usage, rendering execution nodes ranked top three may be determined as target rendering execution nodes.

Operation 104: Transfer the resource rendering request to the rendering execution node according to the node path.

The resource rendering request may instruct the rendering execution node to render the target object by using the cloud.

For example, still referring to FIG. 3A, it is assumed that a resource rendering request generated by the node 7 is transferred to a rendering execution node 1, the resource rendering request may be transmitted from the node 7 to the node 5 and transmitted to the node 2 and to the rendering execution node 1 according to a node path from the node 7 to the rendering execution node.

In some embodiments, when a node triggers to generate a resource rendering request, the resource rendering request may be encrypted. In actual application, a symmetric encryption algorithm (DES, AES) or an asymmetric encryption algorithm (DSA) may be used for encrypting the resource rendering request, and when the resource rendering request is transmitted to the rendering execution node according to the node path, the rendering execution node may decrypt the resource rendering request, to ensure security of the resource rendering request in a transmission process.

Operation 105: Receive the rendering resource corresponding to the target object and returned by the rendering execution node, and display the rendering resource.

The rendering resource may be a resource obtained after the cloud renders the target object.

There may be multiple manners of receiving the rendering resource corresponding to the target object and returned by the rendering execution node, and displaying the rendering resource. For example, a resource transmission path from the rendering execution node to the node may be identified based on the node relationship graph, the rendering resource corresponding to the target object and returned by the rendering execution node is received by using the resource transmission path, and the rendering resource is transmitted to the target node for display according to the resource transmission path.

The resource transmission path may be a path for transmitting the rendering resource from the rendering execution node to the target node in the geographical area. The target node may be a node that is in the geographical area and that needs to display the rendering resource.

There may be multiple manners of transmitting the rendering resource to the target node for display according to the resource transmission path. For example, the rendering resource may be displayed in the geographical area according to whether the node in the geographical area needs to obtain the rendering resource. In some embodiments, a resource rendering request status corresponding to the node may be obtained, a target node is determined in the node according to the resource rendering request status, and the rendering resource is transmitted to the target node for display based on the resource transmission path.

The resource rendering request status may be a status in which each node requests to perform resource rendering. For example, the resource rendering request status may include a status such as whether a resource rendering request being processed exists, a rendering object for which the resource rendering request is being processed, and whether to receive a rendering resource generated by another node. In this way, a rendering resource may be transmitted to a corresponding node in the geographical area for display according to a resource rendering request status of each node in the geographical area, so as to improve resource rendering efficiency.

In some embodiments, after a rendering resource returned for a resource rendering request triggered by any node in the geographical area is received, the rendering resource may be transmitted, according to the node relationship graph, to a node that is in the geographical area and that is used for displaying the rendering resource for display. In this way, an interaction requirement of a real-time interactive cloud rendering scenario can be met, for example, interaction between teammates in the same game level, so that the rendering resource requested by any node in the geographical area is reused in the geographical area, and overheads of a cloud rendering instance on the cloud are greatly reduced. In addition, nodes in the geographical area can synchronously operate the same cloud rendering instance, thereby implementing stronger interaction of cloud rendering and improving resource rendering efficiency.

In some embodiments, the resource rendering method may be integrated into the resource rendering system or the resource rendering apparatus. The rendering execution node and another node in the geographical area may be integrated into the resource rendering system and the resource rendering apparatus. When multiple resource rendering requests are simultaneously generated in the geographical area, to ensure that a resource rendering request of each node can be processed in a timely manner, and ensure that the rendering execution node does not experience a problem such as a performance bottleneck and crash because pixel video streams corresponding to multiple rendering resources are cached, in some embodiments, when receiving multiple to-be-uploaded resource rendering requests, the rendering execution node may obtain rendering request parameters corresponding to the to-be-uploaded resource rendering requests, and perform combination processing on the to-be-uploaded resource rendering requests based on the rendering request parameters to obtain at least one target resource rendering request and upload the target resource rendering request to the cloud.

The to-be-uploaded resource rendering request may be a resource rendering request triggered by a node in the geographical area and received by the rendering execution node. The rendering request parameter may be a parameter corresponding to the to-be-uploaded resource rendering request. For example, the to-be-uploaded resource rendering request may include a rendering object and a rendering type that are corresponding to the to-be-uploaded resource rendering request. The rendering object may be a to-be-rendered object. The rendering type may be a type of rendering the rendering object. For example, for a resource rendering request of a map view, the rendering type may include a rendering type such as a move forward operation or a rotate operation on the rendering object. The target resource rendering request may be a resource rendering request obtained after combination processing is performed on the to-be-uploaded resource rendering requests.

Based on the rendering request parameter, there may be multiple manners of performing combination processing on the to-be-uploaded resource rendering requests. For example, the to-be-uploaded resource rendering requests may be classified according to a rendering request parameter corresponding to each to-be-uploaded resource rendering request, and to-be-uploaded resource rendering requests of the same category are combined, so as to obtain target resource rendering requests of at least one category. For example, to-be-uploaded resource rendering requests for the same rendering object may be combined into the same target resource rendering request according to a rendering object corresponding to each to-be-uploaded resource rendering request. In this way, when receiving the rendering resource returned by the cloud for the target resource rendering request, the rendering execution node may transmit the rendering resource along the path in the node relationship graph to a corresponding node for display. In this way, a quantity of resource rendering requests can be reduced, so that occupation of the cloud resource can be reduced, and reuse of the rendering resource in the geographical area can be improved, thereby improving resource rendering efficiency.

When there are more target resource rendering requests triggered in the geographical area, the target resource rendering requests may be uploaded to the cloud in groups when the target resource rendering requests are uploaded to the cloud, so as to maintain normal running of the rendering execution node. In some embodiments, request time corresponding to the target resource rendering requests may be obtained, and the target resource rendering requests are sorted based on the request time to obtain sorted resource rendering requests, obtain request grouping parameters, and group the sorted resource rendering requests according to the request grouping parameters, to obtain grouped resource rendering requests, and upload the grouped resource rendering requests to the cloud.

The request time may be time of generating the resource rendering request. In some embodiments, for request time of a target resource rendering request obtained by combining multiple to-be-uploaded resource rendering requests, request time corresponding to the multiple to-be-uploaded resource rendering requests may be averaged, and the request time corresponding to the target resource rendering request is obtained according to the average time. In some other embodiments, for a target resource rendering request obtained by combining multiple to-be-uploaded resource rendering requests, request time of the target resource rendering request may be earliest request time of request time corresponding to the multiple to-be-uploaded resource rendering requests. The sorted resource rendering requests may be a result of sorting the target resource rendering requests according to the request time, and the request grouping parameters may include a capacity of each group, that is, a maximum quantity of resource rendering requests that can be accommodated in each group. The grouped resource rendering requests may be a result of grouping the sorted resource rendering requests based on the request grouping parameters. In some embodiments, the sorted resource rendering requests may be uniformly placed in a message queue, and the sorted resource rendering requests are grouped by using a fixed-size message queue. The message queue may be a message queue used for caching resource rendering requests, and a size of the message queue may be determined according to performance of such as a central processing unit (CPU) or a memory of a current rendering execution node device. In this way, a sequence of uploading each target resource rendering request to the cloud may be arranged according to request time corresponding to each target resource rendering request. In addition, the sorted target resource rendering requests may be uploaded to the cloud in a group form, and target resource rendering requests in each group are uploaded to the cloud simultaneously, thereby improving upload efficiency.

In some embodiments, when a large quantity of resource rendering requests are generated in the geographical area, a quantity of rendering execution nodes in the geographical area may be increased, thereby reducing resource pressure of rendering execution nodes in the geographical area.

There may be multiple manners in which the rendering execution node uploads the grouped resource rendering requests in the geographical area to the cloud. For example, the grouped resource rendering requests may be uploaded to the cloud by using web real-time communications (WebRTC), and rendering resources returned by the cloud may be received by also using the WebRTC.

FIG. 3C is another schematic flowchart of a resource rendering method according to some embodiments. After receiving the resource rendering request collected by the node along the node relationship graph in the geographical area, the rendering execution node decrypts the resource rendering request, and uniformly places to-be-uploaded resource rendering requests into a message queue. After the to-be-uploaded resource rendering requests are combined, sorted, and grouped, interaction instructions such as grouped resource rendering requests are uploaded, by using a WebRTC SDK, to a cloud rendering computing node corresponding to the cloud according to a sequence of the grouped resource rendering requests, then a rendering instance is created by using a rendering service of the cloud rendering node, a pixel frame corresponding to each resource rendering request is produced by rendering, and then a pixel stream (that is, a rendering resource) of the generated cloud rendering instance is transmitted, by using a push stream service, to the WebRTC SDK corresponding to the rendering execution node for receiving, so that the rendering resource can be delivered to the node in the geographical area according to a topology structure in the node relationship graph. In some embodiments, pixel streams corresponding to the rendering resource may be received in a multiplexing manner. Correspondingly, for an ordinary node in the geographical area, the rendering resource may be transmitted in the geographical area along the node relationship graph, so that decoding and display can be performed on a corresponding node.

In some embodiments, after the grouped resource rendering requests are uploaded to the cloud, because rendering resources returned by the cloud are returned in a group form simultaneously, rendering resources in the group need to be distributed to corresponding nodes. For example, rendering resource groups returned by the cloud for the grouped resource rendering requests may be received, header information of the candidate rendering resource is extracted, a resource display parameter corresponding to the candidate rendering resource is determined based on the header information, and the candidate rendering resource is transmitted to a corresponding node by using the node relationship graph according to the resource display parameter.

The rendering resource group may include at least one candidate rendering resource. The candidate rendering resource may be a rendering resource returned by the cloud for the grouped resource rendering requests. The header information may be information marked in a header of a data packet corresponding to the candidate rendering resource. The resource display parameter may be a parameter for describing display of the candidate rendering resource in the geographical area, and may include a display range and a display time that are corresponding to the candidate rendering resource. For example, the resource display parameter may include information such as a node on which the candidate rendering resource is displayed, or real-time display is performed on all nodes in the geographical area. In this way, a display node corresponding to each candidate display resource may be determined according to the resource display parameter, so that the candidate rendering resource can be transmitted to a corresponding display node by using the node relationship graph.

In a cloud rendering product in a related technology, for example, in a cloud rendering map product, because costs of a cloud rendering instance running in the cloud are relatively high, multiple user terminals distributed on the same computing node are allocated to different cloud rendering instances when viewing the same map view information, and an instance cannot be reused, resulting in excessively high occupation of a quantity of concurrent resources in the cloud. In addition, a resource occupied by a single instance is excessively large, which overall affects subsequent scalability of a service resource. According to the resource rendering method provided in some embodiments, distributed trusted transmission between mobile terminal devices is implemented in an edge-based computing manner on a premise of ensuring privacy of a user, and a pixel stream of a cloud rendering instance in a geographical area is transmitted and reused on the mobile terminal device. In addition, a rendering execution node is selected from nodes in the geographical area, and rendering interaction between a node in the geographical area and the cloud is unified by using the rendering execution node. A rendering resource is transmitted to the node in the geographical area by using the node relationship graph, so that reuse of a cloud rendering video stream in the geographical area can be implemented, and interaction and rendering efficiency of cloud rendering are improved.

It may be learned from the foregoing that, in some embodiments, a resource rendering request for a target object in a geographical area is obtained. Based on the resource rendering request, a node relationship graph corresponding to the geographical area is obtained, the node relationship graph including at least one node in a connection relationship, the node corresponding to a terminal in the geographical area, and the node including a common rendering execution node shared by nodes in the geographical area; in the node relationship graph, a node path from the node to the rendering execution node is identified; the resource rendering request is transferred to the rendering execution node according to the node path, the resource rendering request being used for instructing the rendering execution node to render the target object by using a cloud to obtain a rendering resource; and the rendering resource corresponding to the target object and returned by the rendering execution node is received, and the rendering resource is displayed. In this way, the resource rendering request is transferred according to the node relationship graph corresponding to the node in the geographical area, so that the rendering execution node uniformly manages resource rendering requests of all nodes in the geographical area, so that the node in the geographical area can receive the rendering resource corresponding to the target object and returned by the rendering execution node for display, so that the requested rendering resource in the same geographical area is reused in the geographical area, resource rendering requests generated in the geographical area are reduced, repeated rendering of the same object on the cloud is reduced, resource rendering efficiency is improved, and resource utilization is further improved.

According to the method described in the foregoing embodiment, the following describes the method in detail by using an example.

In some embodiments, that the resource rendering apparatus may be integrated into a computer device is used as an example for description. The resource rendering method is described by using an example in which a terminal is an execution body.

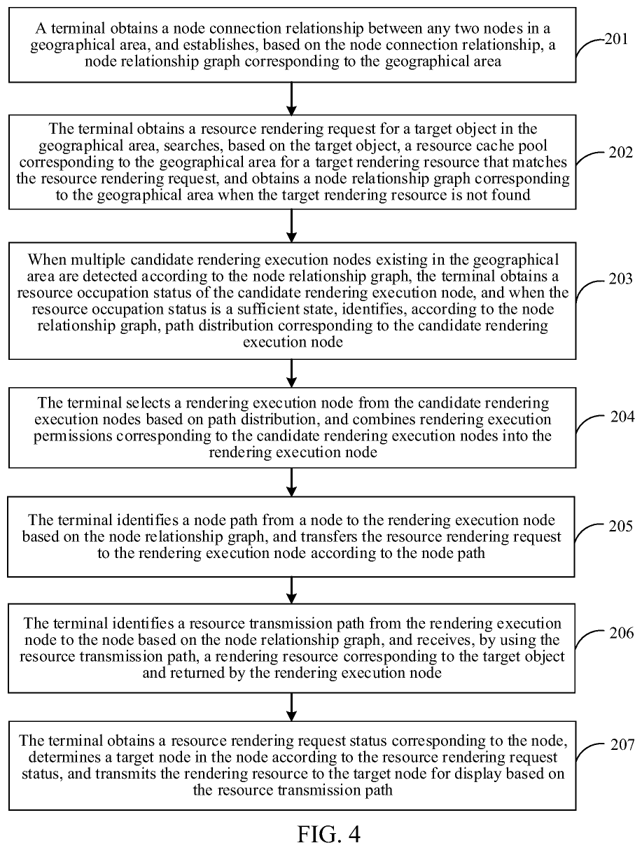

FIG. 4 is a schematic flowchart of a resource rendering method according to some embodiments, and a procedure is as follows:

Operation 201: A terminal obtains a node connection relationship between any two nodes in a geographical area, and establishes, based on the node connection relationship, a node relationship graph corresponding to the geographical area.

There may be multiple manners in which the terminal obtains the node connection relationship between the nodes in the geographical area. For example, a terminal corresponding to a rendering execution node sends heartbeat information to another node in the geographical area, receives response information returned by the another node for the heartbeat information, and determines, from the another node according to the response information, at least one child node corresponding to the rendering execution node. Each child node may send heartbeat information to another node in the geographical area, and then determines, according to response information returned by the another node for the heartbeat information sent by the child node, a next-level child node corresponding to each child node. By analogy, after connection and transmission of the nodes in the current geographical area are stable, a connection relationship between each node in the geographical area and the another node may be obtained, so that the terminal can construct, based on the connection relationship between the nodes, the node relationship graph corresponding to the geographical area.

Operation 202: The terminal obtains a resource rendering request for a target object in the geographical area, searches a resource cache pool corresponding to the geographical area for a target rendering resource that matches the resource rendering request, and obtains a node relationship graph corresponding to the geographical area when the target rendering resource is not found.

In some embodiments, when there are too many resource rendering requests generated in the geographical area, to avoid multiplied occupation and consumption of cloud resources due to repeated requests and repeated resource rendering caused by the same resource rendering request, the terminal may combine obtained resource rendering requests before the resource rendering requests are uploaded to the cloud. In some embodiments, the terminal may combine the resource rendering requests generated in the geographical area according to a rendering object corresponding to each resource rendering request in the geographical area. For example, it is assumed that three resource rendering requests for a target object A (for example, a map view) are obtained in the same geographical area. In this case, the terminal may combine the three resource rendering requests for the target object A into one request, so as to request, based on the request, a rendering resource corresponding to the target object A from the cloud, and then perform distribution on and display the rendering resource according to the three resource rendering requests. For another example, it is assumed that two move forward operations triggered for the same map view are generated in the geographical area at the same time, and generation of two resource rendering requests in response to the move forward operation on the map view is triggered accordingly. In this case, because rendering objects corresponding to the two resource rendering requests are the same, the terminal may combine the two resource rendering requests into one request, and request a rendering resource in response to the move forward operation on the map view from the cloud based on the resource rendering request.

In some embodiments, the terminal may receive, by using a randomly selected rendering execution node, a geographical fence parameter corresponding to the current geographical area delivered by the cloud, and may determine a geographical fence range of the current geographical area according to the geographical fence parameter, so that the rendering execution node can send heartbeat information to a node in the geographical area, so as to establish a connection between nodes in the geographical area. The geographical fence parameter may be a parameter used for determining a range of the geographical area.

In some embodiments, when the target rendering resource is found, the terminal may use the target rendering resource as a rendering resource corresponding to the resource rendering request, and distribute the target rendering resource to a corresponding node for display. In this way, rendering resources for the same object in the same geographical area are reused, and it is unnecessary to repeatedly render the object in the cloud, thereby improving resource rendering efficiency.

In some embodiments, after the terminal obtains the rendering resource from the cloud based on the resource rendering request, the terminal may store the rendering resource in a resource cache pool corresponding to the geographical area. When any node in the geographical area generates a resource rendering request for a specific object, the terminal may search for, according to the object corresponding to the resource rendering request, whether a corresponding rendering resource exists in the resource cache pool, so that reuse of the same rendering resource in the geographical area can be implemented, resource rendering efficiency is improved, resource consumption and resource occupation are reduced, and resource utilization is further improved.

Operation 203: When multiple candidate rendering execution nodes existing in the geographical area are detected according to the node relationship graph, the terminal obtains a resource occupation status of the candidate rendering execution node, and when the resource occupation status is a sufficient state, identifies, according to the node relationship graph, path distribution corresponding to the candidate rendering execution node.

The candidate rendering execution nodes may be multiple rendering execution nodes that exist in the geographical area. The resource occupation status may represent a resource occupation situation of the candidate rendering execution node, and may include resource states such as a sufficient state and a scarce state. The path distribution may be information that represents a connection relationship between the rendering execution node and another node in the geographical area.

There may be multiple manners in which the terminal identifies, according to the node relationship graph, the path distribution corresponding to the candidate rendering execution node. For example, the node relationship graph may be traversed, and the path distribution corresponding to the candidate rendering execution node may be obtained according to a traversal result.

Operation 204: The terminal selects a rendering execution node from the candidate rendering execution nodes based on path distribution, and combines rendering execution permissions corresponding to the candidate rendering execution nodes into the rendering execution node.

Based on the path distribution, there may be multiple manners of selecting the rendering execution node from the candidate rendering execution nodes by the terminal. For example, the terminal may identify path complexity of each candidate rendering execution node according to path distribution corresponding to the candidate rendering execution node, so that a candidate rendering execution node with highest path complexity can be used as a rendering execution node corresponding to the geographical area.

In some embodiments, when the rendering execution node in the geographical area falls back, another node in the geographical area will select a new rendering execution node to be responsible for a resource rendering request in the geographical area and immediately establish a pixel streaming connection to the cloud. In this case, there are very likely multiple rendering execution nodes in the geographical area. Existence of the multiple rendering execution nodes starts multiple cloud rendering instances in the cloud, so as to improve resource occupation of the cloud. After connection and transmission of nodes in a current geographical area are stable, the terminal may dynamically perform a combination operation on rendering execution nodes based on distribution of the rendering execution nodes in the geographical area, and combine structures of the rendering execution nodes, so that resource occupation of a cloud rendering instance can be reduced while the rendering execution nodes are reduced. For example, the terminal may combine multiple rendering execution nodes according to a resource occupation status of each rendering execution node. For example, when a resource occupation rate of the rendering node is relatively low, it may indicate that a management resource that is provided by the rendering execution node in the geographical area and that is for a resource rendering request in the geographical area is excessive. In this case, the multiple rendering execution nodes may be combined according to a resource rendering requirement in the geographical area, to obtain a target rendering node corresponding to the geographical area, so as to reduce a quantity of rendering execution nodes, thereby reducing a start rate and an occupation rate of the cloud resource.

The terminal may combine the multiple rendering execution nodes according to the resource rendering requirement in the geographical area in multiple manners. For example, the terminal may determine a quantity of rendering execution nodes required in the geographical area according to the resource rendering requirement in the geographical area and a resource occupation status of each rendering execution node, so that the multiple rendering execution nodes can be combined according to the quantity of rendering execution nodes.

Based on the quantity of rendering execution nodes, the terminal may combine the multiple rendering execution nodes in multiple manners. For example, rendering nodes that occupy relatively low rendering execution resources may be combined. In some embodiments, the rendering execution nodes may be sorted from the lowest to the highest according to resource usage of each rendering execution node, so that a rendering execution node, in the sorted rendering execution nodes, whose ranking is corresponding to the quantity of rendering execution nodes may be determined as a target rendering execution node, so that a rendering execution permission corresponding to another rendering execution node can be transferred to the target rendering execution node, so as to implement a combination operation on rendering execution nodes. For example, it is assumed that the quantity of rendering execution nodes is 3, after the rendering execution nodes are sorted from the lowest to the highest according to resource usage, the terminal may determine rendering execution nodes ranked top three as target rendering execution nodes.

Operation 205: The terminal identifies a node path from the node to the rendering execution node based on the node relationship graph, and transfers the resource rendering request to the rendering execution node according to the node path.

Based on the node relationship graph, there may be multiple manners of identifying the node path from the node to the rendering execution node by the terminal. For example, the terminal may use the candidate rendering execution node as a child node of the rendering execution node, and maintain a connection relationship between the candidate rendering execution node and the child node, so that the node relationship graph can be updated, and the node path from the node to the rendering execution node can be identified in the updated node relationship graph.

For example, still referring to FIG. 3A, it is assumed that a resource rendering request generated by the node 7 is transferred to a rendering execution node 1, the terminal may transmit the resource rendering request from the node 7 to the node 5 and transmitted to the node 2 and to the rendering execution node 1 according to a node path from the node 7 to the rendering execution node.

In some embodiments, when a node triggers to generate a resource rendering request, the terminal may encrypt the resource rendering request. When the resource rendering request is transmitted to the rendering execution node according to the node path, the rendering execution node may decrypt the resource rendering request, to ensure security of the resource rendering request in a transmission process.

Operation 206: The terminal identifies a resource transmission path from the rendering execution node to the node based on the node relationship graph, and receives, by using the resource transmission path, a rendering resource corresponding to the target object and returned by the rendering execution node.

The resource transmission path may be a path for transmitting the rendering resource from the rendering execution node to the target node in the geographical area.

Operation 207: The terminal obtains a resource rendering request status corresponding to the node, determines a target node in the node according to the resource rendering request status, and transmits the rendering resource to the target node for display based on the resource transmission path.

The resource rendering request status may be a status in which each node requests to perform resource rendering. For example, the resource rendering request status may include a status such as whether a resource rendering request being processed exists, a rendering object for which the resource rendering request is being processed, and whether to receive a rendering resource generated by another node. In this way, a rendering resource may be transmitted to a corresponding node in the geographical area for display according to a resource rendering request status of each node in the geographical area, so as to improve resource rendering efficiency.

In some embodiments, after a rendering resource returned for a resource rendering request triggered by any node in the geographical area is received, the terminal may transmit the rendering resource to a node in the geographical area for display according to the node relationship graph. In this way, an interaction requirement of a real-time interactive cloud rendering scenario can be met, for example, interaction between teammates in the same game level, so that the rendering resource requested by any node in the geographical area is reused in the geographical area, and overheads of a cloud rendering instance on the cloud are greatly reduced. In addition, nodes in the geographical area can synchronously operate the same cloud rendering instance, thereby implementing stronger interaction of cloud rendering and improving resource rendering efficiency.

It may be learned from the foregoing that, in some embodiments, the terminal obtains the node connection relationship between nodes in the geographical area, and establishes, based on the node connection relationship, the node relationship graph corresponding to the geographical area; the terminal obtains the resource rendering request for the target object in the geographical area, searches, based on the target object, the resource cache pool corresponding to the geographical area for the target rendering resource that matches the resource rendering request, and obtains the node relationship graph corresponding to the geographical area when the target rendering resource is not found; when multiple candidate rendering execution nodes existing in the geographical area are detected according to the node relationship graph, the terminal obtains the resource occupation status of the candidate rendering execution node, and when the resource occupation status is the sufficient state, identifies, according to the node relationship graph, path distribution corresponding to the candidate rendering execution node; the terminal selects the rendering execution node from the candidate rendering execution nodes based on path distribution, and combines the rendering execution permissions corresponding to the candidate rendering execution nodes into the rendering execution node; the terminal identifies the node path from the node to the rendering execution node based on the node relationship graph, and transfers the resource rendering request to the rendering execution node according to the node path; the terminal identifies the resource transmission path from the rendering execution node to the node based on the node relationship graph, and receives, by using the resource transmission path, the rendering resource corresponding to the target object and returned by the rendering execution node; and the terminal obtains the resource rendering request status corresponding to the node, determines the target node in the node according to the resource rendering request status, and transmits the rendering resource to the target node for display based on the resource transmission path. In this way, the node relationship graph corresponding to the geographical area is constructed according to the connection relationship between the nodes in the geographical area, so that when the resource rendering request is obtained, the resource rendering request is transmitted to the rendering execution node according to the node relationship graph, so that the rendering execution node uniformly manages resource rendering requests of all nodes in the geographical area. In this way, the node in the geographical area may receive the rendering resource corresponding to the target object and returned by the rendering execution node for display, thereby implementing reuse of the rendering resource requested in the same geographical area in the geographical area, reducing resource rendering requests generated in the geographical area, reducing repeated rendering of the same object by the cloud, improving resource rendering efficiency, and further improving resource utilization.

To better implement the foregoing method, some embodiments provide a resource rendering apparatus. The resource rendering apparatus may be integrated into a computer device, and the computer device may be a terminal.

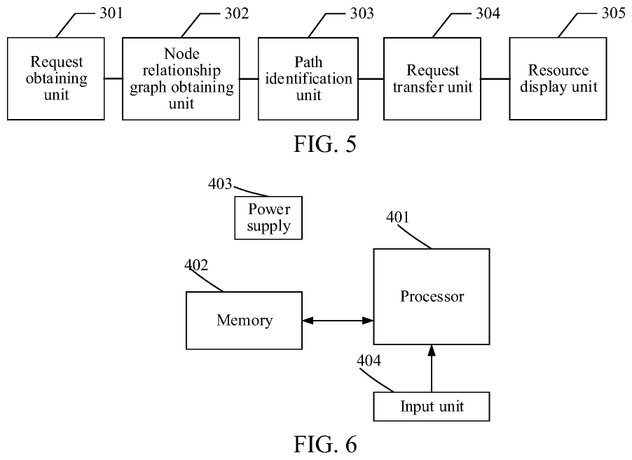

FIG. 5 is a schematic structural diagram of a resource rendering apparatus according to some embodiments. The resource rendering apparatus may include a request obtaining unit 301, a node relationship graph obtaining unit 302, a path identification unit 303, a request transfer unit 304, and a resource display unit 305, as follows:

The request obtaining unit 301 is configured to obtain a resource rendering request for a target object in a geographical area;
the node relationship graph obtaining unit 302 is configured to obtain, based on the resource rendering request, a node relationship graph corresponding to the geographical area, the node relationship graph including at least one node in a connection relationship, the node corresponding to a terminal in the geographical area, and the node including a common rendering execution node shared by nodes in the geographical area;
the path identification unit 303 is configured to identify, in the node relationship graph, a node path from the node to the rendering execution node;
the request transfer unit 304 is configured to transfer the resource rendering request to the rendering execution node according to the node path, the resource rendering request being used for instructing the rendering execution node to render the target object by using a cloud; and
the resource display unit 305 is configured to: receive the rendering resource corresponding to the target object and returned by the rendering execution node, and display the rendering resource.

In some embodiments, the resource display unit 305 includes:
a resource transmission path identification subunit, configured to identify a resource transmission path from the rendering execution node to the node based on the node relationship graph;
a resource receiving subunit, configured to receive, by using the resource transmission path, a rendering resource corresponding to the target object and returned by the rendering execution node; and
a resource transmission subunit, configured to transmit the rendering resource to a target node for display according to the resource transmission path, the target node being a node that displays the rendering resource in the node.

In some embodiments, the resource transmission subunit includes:
a status obtaining module, configured to obtain a resource rendering request status corresponding to the node;
a target node determining module, configured to determine the target node from the node according to the resource rendering request status; and
a resource transmission module, configured to transmit the rendering resource to the target node for display based on the resource transmission path.

In some embodiments, the node relationship graph obtaining unit 302 includes:
a resource searching subunit, configured to search, based on the target object, a resource cache pool corresponding to the geographical area for a target rendering resource that matches the resource rendering request; and
a relationship graph obtaining subunit, configured to obtain, in a case that the target rendering resource is not found, the node relationship graph corresponding to the geographical area.

In some embodiments, the resource rendering apparatus further includes:
a node connection relationship obtaining unit, configured to obtain a node connection relationship between nodes in the geographical area; and
a node relationship graph construction unit, configured to construct, based on the node connection relationship, the node relationship graph corresponding to the geographical area.

In some embodiments, the resource rendering apparatus further includes:
a status detection unit, configured to detect a node status of a parent node corresponding to a current node;
a node searching unit, configured to search, in a case that the node status is a heartbeat fallback state, the geographical area for a neighboring node based on the node relationship graph;
a connection unit, configured to use the neighboring node as a new parent node of the current node, and establish a connection to the new parent node; and
an update unit, configured to update the node relationship graph based on a connection relationship between the current node and the new parent node.

In some embodiments, the path identification unit 303 includes:
a resource occupation status subunit, configured to: when multiple candidate rendering execution nodes existing in the geographical area are detected according to the node relationship graph, obtain a resource occupation status of the candidate rendering execution node;
a path distribution identification subunit, configured to: identify, based on the node relationship graph in a case that the resource occupation status is a sufficient state, path distribution corresponding to the candidate rendering execution node;
a node combination subunit, configured to: select the rendering execution node from the candidate rendering execution nodes based on path distribution, and combine rendering execution permissions corresponding to the candidate rendering execution nodes into the rendering execution node; and
a node path identification subunit, configured to identify, in the node relationship graph, a node path from the node to the rendering execution node.

In some embodiments, the resource rendering apparatus further includes:
a parameter obtaining unit, configured to: obtain, in a case that multiple to-be-uploaded resource rendering requests are received, render request parameters corresponding to the to-be-uploaded resource rendering requests;
a request combination unit, configured to combine the to-be-uploaded resource rendering requests based on the rendering request parameters, to obtain at least one target resource rendering request; and
a request uploading unit, configured to upload the target resource rendering request to the cloud.

In some embodiments, the request uploading unit includes:
a sorting subunit, configured to: obtain request time corresponding to the target resource rendering request, and sort the target resource rendering request based on the request time to obtain a sorted resource rendering request;
a grouping subunit, configured to obtain a request grouping parameter, and group the sorted resource rendering request according to the request grouping parameter, to obtain a grouped resource rendering request; and
an uploading subunit, configured to upload the grouped resource rendering request to the cloud.

In some embodiments, the resource rendering apparatus further includes:
a rendering resource group receiving unit, configured to receive a rendering resource group returned by the cloud for the grouped resource rendering request, the rendering resource group including at least one candidate rendering resource;
a resource display parameter determining unit, configured to: extract packet header information of the candidate rendering resource, and determine, based on the packet header information, a resource display parameter corresponding to the candidate rendering resource; and
a candidate rendering resource parameter unit, configured to transmit the candidate rendering resource to a corresponding node according to the resource display parameter by using the node relationship graph.

In some embodiments, the foregoing various units may be implemented as independent entities, or may be randomly combined, or may be implemented as the same entity or several entities. For specific implementation of the foregoing various units, refer to the foregoing method embodiments. Details are not described herein again.

It may be learned from the foregoing that, in some embodiments, the resource rendering request for the target object in the geographical area is obtained by using the request obtaining unit 301; based on the resource rendering request, the node relationship graph obtaining unit 302 obtains the node relationship graph corresponding to the geographical area, the node relationship graph including at least one node in a connection relationship, the node corresponding to a terminal in the geographical area, and the node including a common rendering execution node shared by nodes in the geographical area; the path identification unit 303 identifies the node path from the node to the rendering execution node in the node relationship graph; the request transfer unit 304 transfers the resource rendering request to the rendering execution node according to the node path, the resource rendering request being used for instructing the rendering execution node to render the target object by using a cloud; and the resource display unit 305 receives the rendering resource corresponding to the target object and returned by the rendering execution node, and displays the rendering resource. In this way, the resource rendering request is transferred according to the node relationship graph corresponding to the node in the geographical area, so that the rendering execution node uniformly manages resource rendering requests of all nodes in the geographical area, so that the node in the geographical area can receive the rendering resource corresponding to the target object and returned by the rendering execution node for display, so that the requested rendering resource in the same geographical area is reused in the geographical area, resource rendering requests generated in the geographical area are reduced, repeated rendering of the same object on the cloud is reduced, resource rendering efficiency is improved, and resource utilization is further improved.

A person skilled in the art would understand that these “units” could be implemented by hardware logic, a processor or processors executing computer software code, or a combination of both. The “units” may also be implemented in software stored in a memory of a computer or a non-transitory computer-readable medium, where the instructions of each unit are executable by a processor to thereby cause the processor to perform the respective operations of the corresponding unit.

Some embodiments provide a computer device. FIG. 6 is a schematic structural diagram of a computer device according to some embodiments. The computer device may be a terminal.

The computer device may include components such as a processor 401 of one or more processing cores, a memory 402 of one or more computer readable storage media, a power supply 403, and an input unit 404. A person skilled in the art can understand that, a structure of the computer device shown in FIG. 6 does not constitute a limitation on the computer device, and may include more or fewer components than those shown in the figure, or some components may be combined, or a different component deployment may be used.

The processor 401 is a control center of the computer device, connects various parts of the entire computer device by using various interfaces and lines, and executes various functions of the computer device and processes data by running or executing a software program and/or a module stored in the memory 402 and invoking data stored in the memory 402. In some embodiments, the processor 401 may include one or more processing cores. For example, the processor 401 may integrate an application processor and a modem. The application processor mainly processes an operating system, a user interface, an application program, and the like. The modem mainly processes wireless communication. It may be understood that the foregoing modem may either not be integrated into the processor 401.

The memory 402 may be configured to store a software program and module. The processor 401 runs the software program and module stored in the memory 402, to execute various functional applications and resource rendering. The memory 402 may mainly include a program storage area and a data storage area. The program storage area may store an operating system, an application program required by at least one function (for example, a sound playing function and an image playing function), or the like. The data storage area may store data created according to use of the computer device, and the like. In addition, the memory 402 may include a high speed random access memory, and may also include a non-volatile memory, such as at least one magnetic disk storage device, a flash memory, or another volatile solid-state storage device. Correspondingly, the memory 402 may further include a memory controller, to provide access of the processor 401 to the memory 402.

The computer device further includes the power supply 403 for supplying power to the components. For example, the power supply 403 may be logically connected to the processor 401 by using a power supply management system, thereby implementing functions, such as charging, discharging, and power consumption management, by using the power supply management system. The power supply 403 may further include one or more of a direct current or alternating current power supply, a re-charging system, a power failure detection circuit, a power supply converter or inverter, a power supply state indicator, and any other components.

The computer device may further include the input unit 404. The input unit 404 may be configured to receive entered numeric or character information and generate keyboard, mouse, joystick, optical, or trackball signal input related to user settings and function control.

Although not shown, the computer device may further include a display unit, and the like. Details are not described herein. In some embodiments, the processor 401 in the computer device may load, according to the following instructions, executable files corresponding to processes of one or more application programs into the memory 402. The processor 401 runs the application programs stored in the memory 402, to implement various functions, for example:
obtaining a resource rendering request for a target object in a geographical area; obtaining, based on the resource rendering request, a node relationship graph corresponding to the geographical area, the node relationship graph including at least one node in a connection relationship, the node corresponding to a terminal in the geographical area, and the node including a common rendering execution node shared by nodes in the geographical area; identifying, in the node relationship graph, a node path from the node to the rendering execution node; transferring the resource rendering request to the rendering execution node according to the node path, the resource rendering request being used for instructing the rendering execution node to render the target object by using a cloud; and receiving the rendering resource corresponding to the target object and returned by the rendering execution node, and displaying the rendering resource.

For specific implementations of the above operations, refer to the foregoing embodiments. Details are not described herein again. The computer device provided in some embodiments and the resource rendering method in the foregoing embodiment belong to the same concept. For a specific implementation process, refer to the foregoing method embodiment. Details are not described herein again.

A person of ordinary skill in the art may understand that, all or some operations of the methods in the foregoing embodiments may be implemented by using instructions, or implemented through instructions controlling relevant hardware, and the instructions may be stored in a computer-readable storage medium and loaded and executed by a processor.

Therefore, some embodiments provide a computer readable storage medium, where the computer readable storage medium stores multiple instructions, and the instructions can be loaded by a processor to perform the operations in any resource rendering method provided in some embodiments. For example, the instructions may perform the following operations:
obtaining a resource rendering request for a target object in a geographical area; obtaining, based on the resource rendering request, a node relationship graph corresponding to the geographical area, the node relationship graph including at least one node in a connection relationship, the node corresponding to a terminal in the geographical area, and the node including a common rendering execution node shared by nodes in the geographical area; identifying, in the node relationship graph, a node path from the node to the rendering execution node; transferring the resource rendering request to the rendering execution node according to the node path, the resource rendering request being used for instructing the rendering execution node to render the target object by using a cloud; and receiving the rendering resource corresponding to the target object and returned by the rendering execution node, and displaying the rendering resource.

The computer readable storage medium may include: a read-only memory (ROM), a random access memory (RAM), a magnetic disk, an optical disc, or the like.

Because the instructions stored in the computer readable storage medium may perform the operations in any resource rendering method provided in some embodiments, beneficial effects that can be implemented in any resource rendering method provided in some embodiments may be implemented. For details, refer to the foregoing embodiments, and details are not described herein again.

Some embodiments provide a computer program product or a computer program, the computer program product or the computer program including computer instructions, the computer instructions being stored in a computer readable storage medium. A processor of a computer device reads the computer instructions from the computer readable storage medium, and the processor executes the computer instructions, so that the computer device performs the method provided in the foregoing embodiments.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A resource rendering method, performed by a computer device, comprising:
obtaining, based on a resource rendering request for a target object in a geographical area, a node relationship graph corresponding to the geographical area, the node relationship graph comprising at least one node in a connection relationship, the at least one node corresponding to a terminal in the geographical area, and the at least one node comprising a rendering execution node shared by nodes in the geographical area;
identifying, in the node relationship graph, a node path from the at least one node to the rendering execution node;
transferring the resource rendering request to the rendering execution node according to the node path, the resource rendering request instructing the rendering execution node to render the target object by using a cloud to obtain a rendering resource; and
receiving the rendering resource returned by the rendering execution node, and displaying the rendering resource.

2. The resource rendering method according to claim 1, wherein the receiving comprises:
identifying a resource transmission path from the rendering execution node to the at least one node based on the node relationship graph;
receiving, by using the resource transmission path, the rendering resource returned by the rendering execution node; and
transmitting the rendering resource to a target node for display according to the resource transmission path.

3. The resource rendering method according to claim 2, wherein the transmitting comprises:
obtaining a resource rendering request status corresponding to the at least one node;
determining the target node from the at least one node according to the resource rendering request status; and
transmitting the rendering resource to the target node for display based on the resource transmission path.

4. The resource rendering method according to claim 1, wherein the obtaining comprises:
searching a resource cache pool corresponding to the geographical area for a target rendering resource that matches the resource rendering request; and
obtaining, based on the target rendering resource not being found, the node relationship graph corresponding to the geographical area.

5. The resource rendering method according to claim 1, wherein before the obtaining, the resource rendering method further comprises:
obtaining a node connection relationship between any two nodes in the geographical area; and
constructing, based on the node connection relationship, the node relationship graph corresponding to the geographical area.

6. The resource rendering method according to claim 1, wherein the node relationship graph comprises a parent node and a child node, and the resource rendering method further comprises:
detecting a node status of the parent node corresponding to a current node;
searching, based on the node status being a heartbeat fallback state, the geographical area for a neighboring node of the current node based on the node relationship graph;
using the neighboring node as a new parent node of the current node, and establishing a connection to the new parent node; and
updating the node relationship graph based on a connection relationship between the current node and the new parent node.

7. The resource rendering method according to claim 1, wherein before the identifying, the resource rendering method further comprises:
separately obtaining, based on multiple candidate rendering execution nodes existing in the node relationship graph, a resource occupation status of each candidate rendering execution node;
identifying, according to the node relationship graph based on the resource occupation status being a sufficient state, path distribution corresponding to the candidate rendering execution node; and
obtaining a rendering execution node from the multiple candidate rendering execution nodes through screening based on the path distribution, and combining rendering execution permission of the multiple candidate rendering execution nodes into the rendering execution node.

8. The resource rendering method according to claim 1, wherein the method further comprises:
obtaining, based on multiple to-be-uploaded resource rendering requests being received, rendering request parameters corresponding to the to-be-uploaded resource rendering requests;
combining the multiple to-be-uploaded resource rendering requests based on the rendering request parameters, to obtain at least one target resource rendering request; and
uploading the at least one target resource rendering request to the cloud.

9. The resource rendering method according to claim 8, wherein the uploading comprises:
obtaining, based on there being multiple target resource rendering requests, a request time of each target resource rendering request, and sorting the multiple target resource rendering requests based on the request time, to obtain sorted target resource rendering requests;
obtaining a request grouping parameter, and grouping the sorted target resource rendering requests based on the request grouping parameter, to obtain grouped target resource rendering requests; and
uploading the grouped target resource rendering requests to the cloud.

10. The resource rendering method according to claim 9, wherein after uploading the grouped target resource rendering requests to the cloud, the resource rendering method further comprises:
receiving a rendering resource group returned by the cloud for the grouped target resource rendering requests, the rendering resource group comprising at least one candidate rendering resource;
extracting packet header information of the candidate rendering resource, and determining, based on the packet header information, a resource display parameter corresponding to the candidate rendering resource; and
transmitting the candidate rendering resource to a corresponding node according to the resource display parameter and the node relationship graph.

11. A resource rendering apparatus, comprising:
at least one memory configured to store program code; and
at least one processor configured to read the program code and operate as instructed by the program code, the program code comprising:
node relationship graph obtaining code configured to cause at least one of the at least one processor to obtain, based on a resource rendering request for a target object in a geographical area, a node relationship graph corresponding to the geographical area, the node relationship graph comprising at least one node in a connection relationship, the at least one node corresponding to a terminal in the geographical area, and the at least one node comprising a rendering execution node shared by nodes in the geographical area;
path identification code configured to cause at least one of the at least one processor to identify, in the node relationship graph, a node path from the at least one node to the rendering execution node;
request transfer code configured to cause at least one of the at least one processor to transfer the resource rendering request to the rendering execution node according to the node path, the resource rendering request instructing the rendering execution node to render the target object by using a cloud to obtain a rendering resource; and
resource display code configured to cause at least one of the at least one processor to receive the rendering resource returned by the rendering execution node, and display the rendering resource.

12. The resource rendering apparatus according to claim 11, wherein the resource display code is further configured to cause at least one of the at least one processor to:
identify a resource transmission path from the rendering execution node to the at least one node based on the node relationship graph;
receive, by using the resource transmission path, the rendering resource returned by the rendering execution node; and
transmit the rendering resource to a target node for display according to the resource transmission path.

13. The resource rendering apparatus according to claim 12, wherein the resource display code is further configured to cause at least one of the at least one processor to:
obtain a resource rendering request status corresponding to the at least one node;
determine the target node from the at least one node according to the resource rendering request status; and
transmit the rendering resource to the target node for display based on the resource transmission path.

14. The resource rendering apparatus according to claim 11, wherein the node relationship graph obtaining code is further configured to cause at least one of the at least one processor to:
search a resource cache pool corresponding to the geographical area for a target rendering resource that matches the resource rendering request; and
obtain, based on the target rendering resource not being found, the node relationship graph corresponding to the geographical area.

15. The resource rendering apparatus according to claim 11, wherein the program code further comprises:
node connection relationship obtaining code configured to cause at least one of the at least one processor to obtain a node connection relationship between any two nodes in the geographical area; and
node relationship graph construction code configured to cause at least one of the at least one processor to construct, based on the node connection relationship, the node relationship graph corresponding to the geographical area.

16. The resource rendering apparatus according to claim 11, wherein the node relationship graph comprises a parent node and a child node, and wherein the program code further comprises:
status detection code configured to cause at least one of the at least one processor to detect a node status of the parent node corresponding to a current node;
node searching code configured to cause at least one of the at least one processor to search, based on the node status being a heartbeat fallback state, the geographical area for a neighboring node of the current node based on the node relationship graph;
connection code configured to cause at least one of the at least one processor to use the neighboring node as a new parent node of the current node, and establish a connection to the new parent node; and
update code configured to cause at least one of the at least one processor to update the node relationship graph based on a connection relationship between the current node and the new parent node.

17. The resource rendering apparatus according to claim 11, wherein the path identification code is further configured to cause at least one of the at least one processor to:
separately obtain, based on multiple candidate rendering execution nodes existing in the node relationship graph, a resource occupation status of each candidate rendering execution node;
identify, according to the node relationship graph based on the resource occupation status being a sufficient state, path distribution corresponding to the candidate rendering execution node; and
obtain a rendering execution node from the multiple candidate rendering execution nodes through screening based on the path distribution, and combine rendering execution permission of the multiple candidate rendering execution nodes into the rendering execution node.

18. The resource rendering apparatus according to claim 11, wherein the program code further comprises:
parameter obtaining code configured to cause at least one of the at least one processor to obtain, based on multiple to-be-uploaded resource rendering requests being received, rendering request parameters corresponding to the to-be-uploaded resource rendering requests;
request combination code configured to cause at least one of the at least one processor to combine the multiple to-be-uploaded resource rendering requests based on the rendering request parameters, to obtain at least one target resource rendering request; and
request uploading code configured to cause at least one of the at least one processor to upload the at least one target resource rendering request to the cloud.

19. The resource rendering apparatus according to claim 18, wherein the request uploading code is further configured to cause at least one of the at least one processor to:
obtain, based on there being multiple target resource rendering requests, a request time of each target resource rendering request, and sort the multiple target resource rendering requests based on the request time, to obtain sorted target resource rendering requests;
obtain a request grouping parameter, and group the sorted target resource rendering requests based on the request grouping parameter, to obtain grouped target resource rendering requests; and
upload the grouped target resource rendering requests to the cloud.

20. A non-transitory computer readable storage medium storing computer code which, when executed by at least one processor, causes the at least one processor to at least:
obtain, based on a resource rendering request for a target object in a geographical area, a node relationship graph corresponding to the geographical area, the node relationship graph comprising at least one node in a connection relationship, the at least one node corresponding to a terminal in the geographical area, and the at least one node comprising a rendering execution node shared by nodes in the geographical area;
identify, in the node relationship graph, a node path from the at least one node to the rendering execution node;
transfer the resource rendering request to the rendering execution node according to the node path, the resource rendering request instructing the rendering execution node to render the target object by using a cloud to obtain a rendering resource; and
receive the rendering resource returned by the rendering execution node, and display the rendering resource.
